(19) United States
(12) Patent Application Publication
(10) Pub. No.: US 2025/0375987 A1
(43) Pub. Date: Dec. 11, 2025

(54) DEFLATION STATE DETECTION SYSTEM, DETERMINATION METHOD, AND PROGRAM

(71) Applicant: Sumitomo Rubber Industries, Ltd., Kobe-shi (JP)

(72) Inventor: Naoki KAJIMOTO, Kobe-shi (JP)

(73) Assignee: Sumitomo Rubber Industries, Ltd., Kobe-shi (JP)

(21) Appl. No.: 19/226,389

(22) Filed: Jun. 3, 2025

(30) Foreign Application Priority Data
Jun. 10, 2024 (JP) 2024-093727

(51) Int. Cl. B60C 23/04; B60Q 9/00; G06Q 10/20

(52) U.S. Cl. CPC B60C 23/0479; B60Q 9/00; G06Q 10/20

(57) ABSTRACT

A vehicle can include a first acquisition processing unit configured to acquire a related value that is related to an air pressure of each tire; a detection processing unit configured to detect a deflation state of the tire, based on the related value and a predetermined reference value; an update processing unit configured to update the reference value if an operation on an initialization button is accepted; and a first determination processing unit configured to determine whether or not the operation on the initialization button is an incorrect operation, based on a stop status of the vehicle during a period from a time of detection of the deflation state to a time of acceptance of the operation on the initialization button.

### CROSS-REFERENCE TO RELATED APPLICATION

This application claims the benefit of foreign priority to Japanese Patent Applications No. JP 2024-093727, filed Jun. 10, 2024, which is hereby incorporated by reference in its entirety.

### BACKGROUND

### Field

The present disclosure relates to a deflation state detection system, a determination method, and a program.

### Background Art

A deflation state detection device can be regarded as a device to detect a deflation state of pneumatic tires mounted on a vehicle, based on the rotation speeds of the pneumatic tires. Specifically, in the deflation state detection device, each time a predetermined acquisition timing arrives, a related value that is related to the air pressure of each pneumatic tire, such as the resonance frequency of each pneumatic tire, is acquired based on the rotation speed. In addition, the deflation state is detected based on the acquired related value and a predetermined reference value.

In the deflation state detection device, the reference value is updated after the deflation state is eliminated. Specifically, in the deflation state detection device, if a predetermined update operation such as an operation on an initialization button is accepted, the reference value is updated based on the related value acquired after the update operation is accepted.

Here, the user of the vehicle may perform the update operation after the deflation state is detected but before the deflation state is eliminated. In this regard, a deflation state detection device that determines that the update operation is an incorrect operation if the difference between two such related values acquired before and after the update operation is accepted is included within a predetermined range, has been known as a related technology (see Japanese Laid-Open Patent Publication No. 2013-249024).

Meanwhile, if the deflation state is eliminated by replacing the pneumatic tire, even if the update operation is performed after the deflation state is eliminated, the difference between the two related values acquired before and after the update operation is accepted may be included within the predetermined range. Therefore, in the above-described deflation state detection device according to the related technology, if the deflation state is eliminated by replacing the pneumatic tire, the update operation may be determined to be an incorrect operation even though the update operation is a correct operation.

An object of the present disclosure is to provide a deflation state detection system, a determination method, and a program that can inhibit an update operation from being determined to be an incorrect operation even though the update operation is a correct operation.

### SUMMARY

A deflation state detection system according to one aspect of the present disclosure can include a first acquisition processing unit, a detection processing unit, an update processing unit, and a first determination processing unit. The first acquisition processing unit can be configured to acquire a related value that is related to an air pressure of each pneumatic tire mounted on a vehicle, based on a rotation speed of the pneumatic tire, each time a predetermined acquisition timing arrives. The detection processing unit can be configured to detect a deflation state of the pneumatic tire, based on the related value acquired by the first acquisition processing unit and a predetermined reference value. The update processing unit can be configured to, if a predetermined update operation is accepted, update the reference value, based on the related value acquired during a first period including a time of acceptance of the update operation. The first determination processing unit can be configured to determine whether or not the update operation is an incorrect operation, based on a stop status of the vehicle during a second period from a time of detection of the deflation state to the time of acceptance of the update operation.

### BRIEF DESCRIPTION OF THE DRAWINGS

FIG. 1 illustrates the configuration of a deflation state detection system according to one or more embodiments of the present disclosure;

FIG. 2 illustrates the configuration of a vehicle of the deflation state detection system according to the embodiment(s) of the present disclosure;

FIG. 3 illustrates the configuration of a server of the deflation state detection system according to the embodiment(s) of the present disclosure;

FIG. 4 is a flowchart showing an example of a related value acquisition process executed by the deflation state detection system according to the embodiment(s) of the present disclosure;

FIG. 5 is a flowchart showing an example of a deflation state detection process executed by the deflation state detection system according to the embodiment(s) of the present disclosure;

FIG. 6 is a flowchart showing an example of an update process executed by the deflation state detection system according to the embodiment(s) of the present disclosure;

FIG. 7 is a flowchart showing an example of an operation determination process executed by the deflation state detection system according to the embodiment(s) of the present disclosure; and

FIG. 8 is a flowchart showing an example of a vehicle guidance process executed by the deflation state detection system according to the embodiment(s) of the present disclosure.

### DETAILED DESCRIPTION

Hereinafter, one or more embodiments of the present disclosure will be described with reference to the accompanying drawings. The following embodiment(s) is/are an example in which the present disclosure can be embodied, and does not limit the technical scope of the present disclosure.

With a deflation state detection system according to one or more embodiments of the present disclosure, whether or not the update operation is an incorrect operation can be determined based on the stop status of the vehicle during the second period from the time of detection of the deflation state to the time of acceptance of the update operation. Accordingly, it can be possible to determine that the update operation is an incorrect operation, only if it can be determined that it is impossible for the user of the vehicle to adjust the air pressure of the pneumatic tire or replace the pneumatic tire during the second period, such as if the vehicle has not stopped during the second period. Therefore, compared to a configuration in which the update operation is determined to be an incorrect operation if the difference between the two related values acquired before and after the update operation is accepted is included within a predetermined range, it can be possible to inhibit the update operation from being determined to be an incorrect operation when the deflation state is eliminated by replacing the pneumatic tire.

According to the present disclosure, it can be possible to inhibit the update operation from being determined to be an incorrect operation even though the update operation is a correct operation.

### [Configuration of Deflation State Detection System 100]

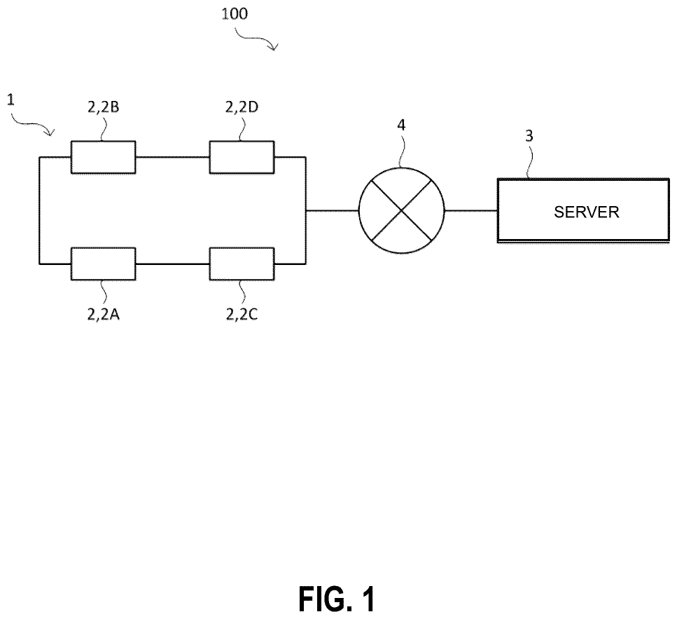

First, the configuration of a deflation state detection system 100 according to the embodiment(s) of the present disclosure will be described with reference to FIG. 1.

The deflation state detection system 100 is capable of determining whether or not a pneumatic tire 2 (see FIG. 1) (hereinafter referred to as “tire 2”) mounted on a vehicle 1 (see FIG. 1) has become deflated. In the deflation state detection system 100, if it is determined that the tire 2 has become deflated, a deflation state of the tire 2 can be detected.

For example, in the deflation state detection system 100, when the air pressure of any of the tires 2 is reduced by a reference pressure loss amount determined in advance from a predetermined optimum value, it can be determined that the tire 2 mounted on the vehicle 1 has become deflated. For example, the reference pressure loss amount may be 20 percent of the optimum value.

As shown in FIG. 1, the deflation state detection system 100 can include the vehicle 1 and a server 3. In the deflation state detection system 100, the vehicle 1 and the server 3 can be connected to each other via a communication network 4 so as to be able to communicate with each other. For example, the communication network 4 can be the Internet.

### [Configuration of Vehicle 1]

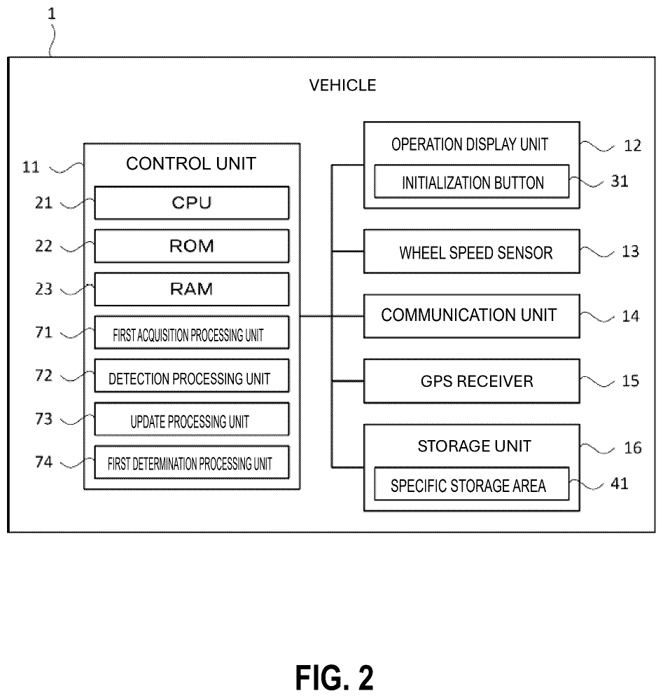

Next, the configuration of the vehicle 1 will be described with reference to FIG. 2.

The vehicle 1 can be an automobile such as a passenger car, a bus, or a truck. The vehicle 1 is not limited to the automobile, and may be a motorcycle, a three-wheeled passenger car, or the like.

As shown in FIG. 1, the vehicle 1 can include four tires 2. Specifically, the vehicle 1 can include four wheels (the wheel on the front left side, the wheel on the front right side, the wheel on the rear left side, and the wheel on the rear right side), and the tires 2 can be mounted on the respective wheels. Hereinafter, the tire 2 mounted on the wheel on the front left side is referred to as “tire 2A” (see FIG. 1). The tire 2 mounted on the wheel on the front right side is referred to as “tire 2B” (see FIG. 1). The tire 2 mounted on the wheel on the rear left side is referred to as “tire 2C” (see FIG. 1). The tire 2 mounted on the wheel on the rear right side is referred to as “tire 2D” (see FIG. 1).

In addition to various components required for traveling such as an engine, the four wheels, the tires 2 (see FIG. 1) mounted on the respective wheels, brakes, and a steering mechanism, the vehicle 1 can include a control unit 11, an operation display unit 12, a wheel speed sensor 13, a communication unit 14, a GPS receiver 15, and a storage unit 16 shown in FIG. 2. The units may be implemented in or using circuitry, such as control circuitry in the case of the control unit 11, display circuitry in the case of the operation display unit 12, sensor circuitry in the case of the wheel speed sensor 13, etc. Optionally, some or all of such components may be referred to as circuitry configured to perform the various functions associated with the components.

The control unit 11 can realize various functions for detecting the deflation state of the tires 2. As shown in FIG. 2, the control unit 11 can include a CPU 21, a ROM 22, and a RAM 23. The CPU 21 can be a processor that executes various arithmetic processes. The ROM 22 can be a nonvolatile storage device in which information such as a control program for causing the CPU 21 to execute various processes is stored in advance. The RAM 23 can be a volatile or nonvolatile storage device that is used as a temporary storage memory (work area) for various processes executed by the CPU 21. The control unit 11 does not have to be specialized for the function of detecting the deflation state of the tires 2.

The operation display unit 12 can include a first display section and a first operation section. The first display section can be provided at a position at which the first display section is visible to a driver sitting in the driver's seat of the vehicle 1. For example, the first display section can be a flat panel display such as a liquid crystal display provided in a center cluster of the vehicle 1. The first display section can display various kinds of information in response to control instructions from the control unit 11. The first operation section can be provided at a position at which the first operation section can be operated by the driver sitting in the driver's seat. For example, the first operation section can be or include operation buttons provided in the center cluster or a center console of the vehicle 1, or can be or include a touch panel provided on the display section. The first display section may also include a notification lamp provided in an instrument panel of the vehicle 1 and corresponding to each of various kinds of notification information to the user of the vehicle 1.

The operation display unit 12 can include an initialization button 31 shown in FIG. 2. For example, the initialization button 31 can be a physical switch provided in the center cluster or the center console of the vehicle 1. The initialization button 31 can be used to update a reference value used for determination as to deflation of the tires 2. As described later, the reference value can be updated when the initialization button 31 is operated.

The wheel speed sensor 13 can be or include a sensor capable of detecting the rotation speed of the wheel (rotation speed of the tire 2). The wheel speed sensor 13 can be provided for each of the wheels. For example, the wheel speed sensor 13 can output an electrical signal corresponding to a change in a magnetic field generated by rotation of a sensor rotor having a plurality of teeth provided inside the wheel. The electrical signal outputted from each wheel speed sensor 13 can be inputted to the control unit 11. The control unit 11 can acquire the rotation speed of each tire 2, based on the electrical signal outputted from each wheel speed sensor 13.

The communication unit 14 can be or include a communication interface capable of executing data communication with external devices. Specifically, the communication unit 14 can execute data communication with the server 3 via the communication network 4.

The GPS receiver 15 can be capable of receiving radio waves transmitted from GPS satellites. The control unit 11 can be capable of acquiring vehicle position information indicating the current position of the vehicle 1, based on information included in radio waves received by the GPS receiver 15.

The storage unit 16 can be or include a nonvolatile storage device. For example, the storage unit 16 can be a nonvolatile memory such as a flash memory.

Map data for a predetermined specific region can be stored in the storage unit 16. The map data can be used in a process of searching for a traveling route from the current position of the vehicle 1 to a destination set by the driver of the vehicle 1 or the like, and this process can be executed by another control unit different from the control unit 11. The specific region may be a region including a plurality of countries, may be a country, or may be a region included in a country.

As shown in FIG. 2, the storage unit 16 can include a specific storage area 41.

The specific storage area 41 can be used to store the vehicle position information. Specifically, the control unit 11 can acquire the vehicle position information at a predetermined acquisition cycle using the GPS receiver 15. In addition, the control unit 11 can add date and time information indicating the current date and time to the acquired vehicle position information. Then, the control unit 11 can store the vehicle position information having the date and time information added thereto, in the specific storage area 41. Multiple pieces of the vehicle position information that are stored in the specific storage area 41 in consecutive order of acquisition can constitute traveling status information indicating the traveling status of the vehicle 1. That is, the traveling status information can be stored in the specific storage area 41.

### [Configuration of Server 3]

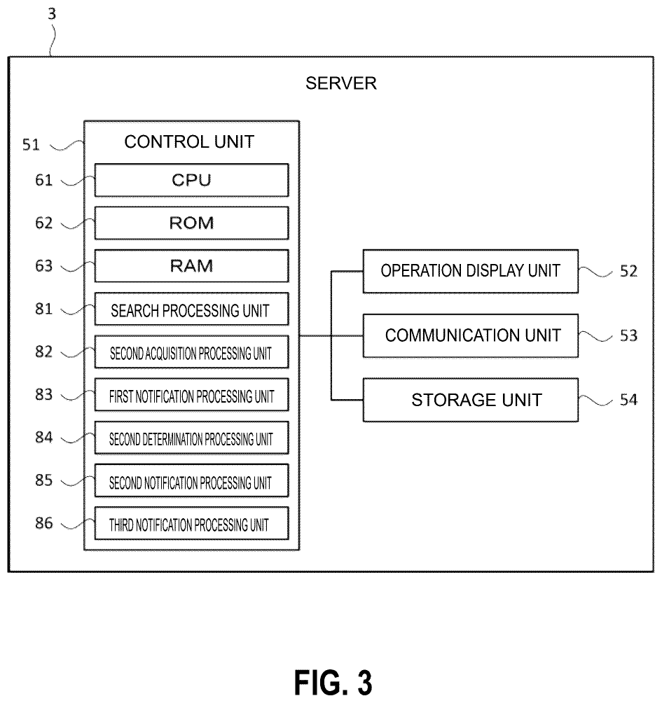

Next, the configuration of the server 3 will be described with reference to FIG. 3.

As shown in FIG. 3, the server 3 can include a control unit 51, an operation display unit 52, a communication unit 53, and a storage unit 54.

The control unit 51 can centrally control the server 3. As shown in FIG. 3, the control unit 51 can include a CPU 61, a ROM 62, and a RAM 63. The CPU 61, the ROM 62, and the RAM 63 may be the same as the CPU 21, the ROM 22, and the RAM 23 of the vehicle 1.

The operation display unit 52 can be or include a user interface of the server 3. The operation display unit 52 can include a second display section and a second operation section. The second display section can display various kinds of information in response to control instructions from the control unit 51. For example, the second display section can be or include a flat panel display such as a liquid crystal display. The second operation section can input various kinds of information to the control unit 51 in response to operations by the user. For example, the second operation section can include a keyboard, a mouse, and a touch panel.

The communication unit 53 can be or include a communication interface capable of executing data communication with external devices. Specifically, the communication unit 53 can execute data communication with the vehicle 1 via the communication network 4.

The storage unit 54 can be or include a nonvolatile storage device. For example, the storage unit 54 can be a storage device, such as a nonvolatile memory such as a flash memory, a solid state drive (SSD), and a hard disk drive (HDD).

The same map data as that stored in the storage unit 16 of the vehicle 1 can be stored in the storage unit 54.

### [Functional Configuration of Control Unit 11]

Next, a functional configuration, included in the control unit 11, for detecting the deflation state of the tires 2 will be described with reference to FIG. 2.

As shown in FIG. 2, the control unit 11 can include a first acquisition processing unit 71, a detection processing unit 72, an update processing unit 73, and a first determination processing unit 74. The deflation state detection system of the present disclosure may be composed only of the control unit 11, according to one or more embodiments of the present disclosure.

Specifically, the CPU 21 of the control unit 11 can function as each of the above-described processing units by executing the control program stored in advance in the ROM 22.

The control program may be recorded in a computer-readable storage medium such as a CD, a DVD, or a flash memory, and read from the storage medium, and stored in the storage unit 16. The control program may be a program for causing a plurality of processors to function as each processing unit shown in FIG. 2. In addition, some or all of the processing units included in the control unit 11 may be composed of an electronic circuit or circuitry.

The first acquisition processing unit 71 can acquire related values that are related to the air pressures of the tires 2 mounted on the vehicle 1, based on the rotation speeds of the tires 2 each time a predetermined acquisition timing arrives.

For example, the first acquisition processing unit 71 can acquire four such related values: DEL1, DEL3, the resonance frequency of the tire 2A, and the resonance frequency of the tire 2B.

DEL1 can be a value that becomes larger as the rotation speed of the tire 2A and the rotation speed of the tire 2D increase and becomes smaller as the rotation speed of the tire 2B and the rotation speed of the tire 2C increase, or a value that becomes smaller as the rotation speed of the tire 2A and the rotation speed of the tire 2D increase and becomes larger as the rotation speed of the tire 2B and the rotation speed of the tire 2C increase.

For example, DEL1 can be calculated according to the following equation (1). “V1” in the equation (1) is the rotation speed of the tire 2A. “V2” in the equation (1) is the rotation speed of the tire 2B. “V3” in the equation (1) is the rotation speed of the tire 2C. “V4” in the equation (1) is the rotation speed of the tire 2D. The rotation speeds of the four tires 2 can be acquired based on the electrical signals outputted from the four wheel speed sensors 13 corresponding to the four tires 2.

DEL1=[(V1+V4)/(V2+V3)−1]×100(%) (1)

DEL3 can be a value that becomes larger as the rotation speed of the tire 2A and the rotation speed of the tire 2C increase and becomes smaller as the rotation speed of the tire 2B and the rotation speed of the tire 2D increase, or a value that becomes smaller as the rotation speed of the tire 2A and the rotation speed of the tire 2C increase and becomes larger as the rotation speed of the tire 2B and the rotation speed of the tire 2D increase.

For example, DEL3 can be calculated according to the following equation (2).

DEL3=[(V1+V3)/(V2+V4)−1]×100(%) (2)

The resonance frequency of the tire 2A can be calculated based on the rotation speed of the tire 2A.

The resonance frequency of the tire 2B can be calculated based on the rotation speed of the tire 2B.

A suitable method for acquiring the resonance frequency of the tire 2 can be used or implemented. For example, the resonance frequency of the tire 2 can be acquired by performing time series analysis, based on a second-order autoregressive (AR) model, on rotational acceleration information calculated from the rotation speed of the tire 2 acquired by the wheel speed sensor 13.

For example, the acquisition timing can be a timing that arrives at a predetermined cycle from the start of traveling of the vehicle 1. For example, the cycle may be 10 minutes. The acquisition timing may be a timing when the vehicle 1 is traveling at a speed equal to or higher than a predetermined speed, the vehicle 1 is not accelerating or decelerating, and the vehicle 1 is not cornering.

The related values acquired by the first acquisition processing unit 71 do not have to be limited to the above-described four values. For example, the related values acquired by the first acquisition processing unit 71 may include the resonance frequency of the tire 2C and the resonance frequency of the tire 2D. In addition, the related values acquired by the first acquisition processing unit 71 may include DEL2. DEL2 can be a value that becomes larger as the rotation speed of the tire 2A and the rotation speed of the tire 2B increase and becomes smaller as the rotation speed of the tire 2C and the rotation speed of the tire 2D increase, or a value that becomes smaller as the rotation speed of the tire 2A and the rotation speed of the tire 2B increase and becomes larger as the rotation speed of the tire 2C and the rotation speed of the tire 2D increase.

The detection processing unit 72 can detect the deflation state of the tires 2, based on each related value acquired by the first acquisition processing unit 71 and a predetermined reference value.

For example, the detection processing unit 72 can detect the deflation state of the tires 2 when the difference between the related value acquired by the first acquisition processing unit 71 and the reference value exceeds a predetermined threshold value.

Here, in the vehicle 1, the reference value and the threshold value corresponding to each of the related values acquired by the first acquisition processing unit 71 can be determined in advance.

For example, the reference value corresponding to DEL1 can be a value that is set based on DEL1 acquired by the first acquisition processing unit 71 in a state where the air pressure of each of the four tires 2 is the optimum value. For example, the reference value corresponding to DEL1 can be the same value as DEL1 acquired by the first acquisition processing unit 71 in a state where the air pressure of each of the four tires 2 is the optimum value. Alternatively, the reference value corresponding to DEL1 may be the average value of multiple DEL1s acquired by the first acquisition processing unit 71 in a state where the air pressure of each of the four tires 2 is the optimum value.

As with the reference value corresponding to DEL1, the reference value corresponding to DEL3 can be a value that is set based on DEL3 acquired by the first acquisition processing unit 71 in a state where the air pressure of each of the four tires 2 is the optimum value.

The reference value corresponding to the resonance frequency of the tire 2A can be a value that is set based on the resonance frequency of the tire 2A acquired by the first acquisition processing unit 71 in a state where the air pressure of the tire 2A is the optimum value. For example, the reference value corresponding to the resonance frequency of the tire 2A can be the same value as the resonance frequency of the tire 2A acquired by the first acquisition processing unit 71 in a state where the air pressure of the tire 2A is the optimum value. Alternatively, the reference value corresponding to the resonance frequency of the tire 2A may be the average value of multiple resonance frequencies of the tire 2A acquired by the first acquisition processing unit 71 in a state where the air pressure of the tire 2A is the optimum value.

As with the reference value corresponding to the resonance frequency of the tire 2A, the reference value corresponding to the resonance frequency of the tire 2B can be a value that is set based on the resonance frequency of the tire 2B acquired by the first acquisition processing unit 71 in a state where the air pressure of the tire 2B is the optimum value.

The threshold value corresponding to DEL1 can be a value that indicates the difference between: DEL1 acquired by the first acquisition processing unit 71 in a state where the air pressure of each of any three tires 2 out of the four tires 2 is the optimum value and the air pressure of the remaining one tire 2 is reduced by the reference pressure loss amount from the optimum value; and the reference value corresponding to DEL1.

The threshold value corresponding to DEL3 can be a value that indicates the difference between: DEL3 acquired by the first acquisition processing unit 71 in a state where the air pressure of each of any three tires 2 out of the four tires 2 is the optimum value and the air pressure of the remaining one tire 2 is reduced by the reference pressure loss amount from the optimum value; and the reference value corresponding to DEL3.

The threshold value corresponding to the resonance frequency of the tire 2A can be a value that indicates the difference between: the resonance frequency of the tire 2A acquired by the first acquisition processing unit 71 in a state where the air pressure of the tire 2A is reduced by the reference pressure loss amount from the optimum value; and the reference value corresponding to the resonance frequency of the tire 2A.

The threshold value corresponding to the resonance frequency of the tire 2B can be a value that indicates the difference between: the resonance frequency of the tire 2B acquired by the first acquisition processing unit 71 in a state where the air pressure of the tire 2B is reduced by the reference pressure loss amount from the optimum value; and the reference value corresponding to the resonance frequency of the tire 2B.

For example, for each of the related values acquired by the first acquisition processing unit 71, the detection processing unit 72 can determine whether or not the difference between the related value and the reference value exceeds the threshold value. Then, the detection processing unit 72 can detect the deflation state of the tires 2 if it is determined for any of the related values that the difference between the related value and the reference value exceeds the threshold value. The detection processing unit 72 may detect the deflation state of the tires 2 if the number of times it is determined for any of the related values that the difference between the related value and the reference value exceeds the threshold value exceeds a predetermined number.

If the deflation state of the tires 2 is detected, the detection processing unit 72 can identify the deflated tire 2.

For example, if the difference between the resonance frequency of the tire 2A and the reference value corresponding to this resonance frequency exceeds the threshold value, the detection processing unit 72 can determine that the tire 2A has been deflated.

If the difference between the resonance frequency of the tire 2B and the reference value corresponding to this resonance frequency exceeds the threshold value, the detection processing unit 72 can determine that the tire 2B has been deflated.

If the difference between the related value of either DEL1 or DEL3 and the reference value corresponding to this related value exceeds the threshold value, the detection processing unit 72 can identify the deflated tire 2, based on the combination of the sign of DEL1 and the sign of DEL3. Specifically, if the sign of DEL1 is positive and the sign of DEL3 is positive, the detection processing unit 72 can determine that the tire 2A has been deflated. If the sign of DEL1 is negative and the sign of DEL3 is negative, the detection processing unit 72 can determine that the tire 2B has been deflated. If the sign of DEL1 is negative and the sign of DEL3 is positive, the detection processing unit 72 can determine that the tire 2C has been deflated. If the sign of DEL1 is positive and the sign of DEL3 is negative, the detection processing unit 72 can determine that the tire 2D has been deflated.

If the deflation state of the tires 2 is detected, the control unit 11 can notify the user of the vehicle 1 of this detection. For example, the control unit 11 can display a message indicating that the deflation state of the tires 2 has been detected and also indicating the deflated tire 2, on the operation display unit 12. The control unit 11 may turn on a notification lamp for notifying that the deflation state of the tires 2 has been detected. The control unit 11 can also periodically generate a predetermined warning sound. Accordingly, the user of the vehicle 1 can recognize the deflation state of the tires 2 and take action to eliminate the deflation state of the tires 2 (adjusting the air pressure of the tire 2 or replacing the tire 2).

The notification that the deflation state of the tires 2 has been detected can continue until an update operation described later is accepted. For example, the control unit 11 can generate the warning sound until the update operation described later is accepted.

In the vehicle 1, each reference value can be updated after the air pressure of the tire 2 is adjusted or the tire 2 is replaced.

If the predetermined update operation is accepted, the update processing unit 73 can update the reference values, based on the related values acquired during a first period including the time of acceptance of the update operation.

For example, the update operation can be or include an operation of pressing the initialization button 31 (see FIG. 2).

For example, the first period can be a period that starts from the time of acceptance of the update operation. The first period can also be a period that ends after the number of times the acquisition timing has arrived from the time of acceptance of the update operation reaches a predetermined number.

If the update operation is accepted, the update processing unit 73 can update the reference value corresponding to each of the related values.

For example, the update processing unit 73 can set any of DEL1s acquired during the first period, as a new reference value corresponding to DEL1. Alternatively, the update processing unit 73 may set the average value of the multiple DEL1s acquired during the first period, as a new reference value corresponding to DEL1.

The update processing unit 73 can set any of DEL3s acquired during the first period, as a new reference value corresponding to DEL3. Alternatively, the update processing unit 73 may set the average value of the multiple DEL3s acquired during the first period, as a new reference value corresponding to DEL3.

The update processing unit 73 can set any of resonance frequencies of the tire 2A acquired during the first period, as a new reference value corresponding to the resonance frequency of the tire 2A. Alternatively, the update processing unit 73 may set the average value of the multiple resonance frequencies of the tire 2A acquired during the first period, as a new reference value corresponding to the resonance frequency of the tire 2A.

The update processing unit 73 can set any of resonance frequencies of the tire 2B acquired during the first period, as a new reference value corresponding to the resonance frequency of the tire 2B. Alternatively, the update processing unit 73 may set the average value of the multiple resonance frequencies of the tire 2B acquired during the first period, as a new reference value corresponding to the resonance frequency of the tire 2B.

The update operation does not have to be limited to the operation on the initialization button 31 (see FIG. 2). For example, the update operation may be or include an operation on an operation key (soft key) displayed on the first display section in accordance with a predetermined operation on the operation display unit 12. In the case where the control unit 11 is connected in advance to a portable terminal such as a smartphone carried by the user of the vehicle 1 so as to be able to communicate therewith, the update operation may be an operation performed on the portable terminal. The first period may be a period that starts before the update operation is accepted.

Meanwhile, the user of the vehicle 1 may perform the update operation after the deflation state of the tires 2 is detected but before the deflation state of the tires 2 is eliminated. For example, in order to stop the warning sound, the user of the vehicle 1 may perform the update operation before the deflation state of the tires 2 is eliminated. In this regard, a deflation state detection device that determines that the update operation is an incorrect operation if the difference between the two related values acquired before and after the update operation is accepted is included within a predetermined range, has been known as a related technology.

Here, when the deflation state of the tires 2 is eliminated by replacing the tire 2, even if the update operation is performed after the deflation state of the tires 2 is eliminated, the difference between the two related values acquired before and after the update operation can be accepted may be included within a predetermined range. Therefore, in the above-described deflation state detection device according to the related technology, when the deflation state of the tires 2 is eliminated by replacing the tire 2, the update operation may be determined to be an incorrect operation even though the update operation is a correct operation.

In contrast, the deflation state detection system 100 according to the embodiment(s) of the present disclosure can inhibit the update operation from being determined to be an incorrect operation even though the update operation is a correct operation as described below.

The first determination processing unit 74 can determine whether or not the update operation is an incorrect operation, based on the stop status of the vehicle 1 during a second period from the time of detection of the deflation state of the tires 2 to the time of acceptance of the update operation.

For example, the first determination processing unit 74 can determine whether or not the update operation is an incorrect operation, based on the stop status and the stop location of the vehicle 1 during the second period.

The stop status of the vehicle 1 during the second period can be acquired based on the traveling status information stored in the specific storage area 41 of the storage unit 16. The stop location of the vehicle 1 during the second period can be identified based on the traveling status information and the map data stored in the storage unit 16. The first determination processing unit 74 may acquire the stop status of the vehicle 1 during the second period, based on the driving status of the engine of the vehicle 1 during the second period.

Specifically, if the vehicle 1 has not stopped during the second period, the first determination processing unit 74 can determine that the update operation is an incorrect operation.

If the vehicle 1 has stopped during the second period and the continuation time of the stopped state of the vehicle 1 does not exceed a predetermined specific time, the first determination processing unit 74 can determine that the update operation is an incorrect operation.

The specific time can be set based on a shorter one of the time required for adjusting the air pressure of the tire 2 and the time required for replacing the tire 2.

If the vehicle 1 has stopped during the second period, the stopped time of the vehicle 1 exceeds the specific time, and the stop location of the vehicle 1 is not at a business place where it is possible to eliminate the deflation state of the tires 2, the first determination processing unit 74 can determine that the update operation is an incorrect operation. Examples of the business place can include gas stations, service stations, car dealers, car maintenance factories, etc.

If the vehicle 1 has stopped during the second period, the stopped time of the vehicle 1 exceeds the specific time, and the stop location of the vehicle 1 is at the business place, the first determination processing unit 74 can determine that the update operation is not an incorrect operation, that is, the update operation is a correct operation.

For example, each time the update operation is accepted, the first determination processing unit 74 can determine whether or not the accepted update operation is an incorrect operation. Each time the update operation is accepted, the first determination processing unit 74 may determine whether or not the accepted update operation is an incorrect operation, until the number of times the update operation is accepted reaches a predetermined number after the time of detection of the deflation state of the tires 2.

If the update operation is determined to be an incorrect operation, the control unit 11 can notify the user of the vehicle 1 that the update operation has been determined to be an incorrect operation. For example, the control unit 11 can display a message indicating that the update operation has been determined to be an incorrect operation, on the operation display unit 12. The control unit 11 may turn on a notification lamp for notifying that the update operation has been determined to be an incorrect operation. The control unit 11 can also periodically generate the above warning sound. Accordingly, it can be possible for the user of the vehicle 1 to recognize that the update operation has been determined to be an incorrect operation.

For example, the control unit 11 can notify that the update operation has been determined to be an incorrect operation, at a timing when notification can be performed by a first notification processing unit 83 described below.

The notification that the update operation has been determined to be an incorrect operation can end after a predetermined time has elapsed. The notification that the update operation has been determined to be an incorrect operation may be continued until the update operation is determined to be a correct operation by the first determination processing unit 74.

The first determination processing unit 74 may determine whether or not the update operation is an incorrect operation, based on the stop status of the vehicle 1 during the second period, the related values acquired during the second period, and the related values acquired after the second period has elapsed.

For example, if any of the differences between the related values acquired during the second period and the related values acquired after the second period has elapsed is not included within a predetermined range, the first determination processing unit 74 may determine that the update operation is a correct operation. If the differences between the related values acquired during the second period and the related values acquired after the second period has elapsed are included within the predetermined range, and the vehicle 1 has not stopped during the second period, the first determination processing unit 74 may determine that the update operation is an incorrect operation. If the differences between the related values acquired during the second period and the related values acquired after the second period has elapsed are included within the predetermined range, and the continuation time of the stopped state of the vehicle 1 during the second period does not exceed the specific time, the first determination processing unit 74 may determine that the update operation is an incorrect operation. If the differences between the related values acquired during the second period and the related values acquired after the second period has elapsed are included within the predetermined range, and the stopped time of the vehicle 1 during the second period exceeds the specific time, the first determination processing unit 74 may determine that the update operation is a correct operation. Accordingly, it can be possible to improve the accuracy of determining whether or not the update operation is an incorrect operation.

In the deflation state detection system 100, if the update operation is determined to be an incorrect operation, the vehicle 1 can be guided to the business place.

### [Functional Configuration of Control Unit 51]

Next, a functional configuration, included in the control unit 51 of the server 3, for guiding the vehicle 1 to the business place will be described with reference to FIG. 3.

As shown in FIG. 3, the control unit 51 can include a search processing unit 81, a second acquisition processing unit 82, the first notification processing unit 83, a second determination processing unit 84, a second notification processing unit 85, and a third notification processing unit 86.

Specifically, a vehicle guidance program for causing the control unit 51 to function as each processing unit shown in FIG. 3 is stored in the storage unit 54 of the server 3 in advance. The CPU 61 of the control unit 51 can function as each of the above-described processing units by executing the vehicle guidance program.

Some or all of the processing units included in the control unit 51 may be composed of an electronic circuit. The vehicle guidance program may be a program for causing a plurality of processors to function as each processing unit shown in FIG. 3.

If the update operation is determined to be an incorrect operation by the first determination processing unit 74, the search processing unit 81 can search for the business place where it is possible to eliminate the deflation state of the tires 2.

For example, the search processing unit 81 can search for the business place that exists within a predetermined specific range from the current position of the vehicle 1. For example, the specific range can be a range with a radius of 5 kilometers from the vehicle 1.

Then, if the business place is not found, the search processing unit 81 can search for the business place each time a predetermined search timing arrives, until the business place is found. For example, the search timing can be a timing that arrives every five minutes. The search timing may be a timing when the vehicle 1 stops such as at a traffic light.

For example, the search processing unit 81 can communicate with the vehicle 1, and can acquire the vehicle position information last acquired by the vehicle 1, from the vehicle 1. In addition, based on the vehicle position information acquired from the vehicle 1 and the map data stored in the storage unit 54, the search processing unit 81 can search for the business place that exists within the specific range from the position of the vehicle 1 that is based on the acquired vehicle position information.

The second acquisition processing unit 82 can acquire a specific route to a specific business place closest to the current position of the vehicle 1 among the business places found by the search processing unit 81.

For example, the second acquisition processing unit 82 can acquire the specific route, based on the map data stored in the storage unit 54.

The first notification processing unit 83 can notify a person in the vehicle 1 of the specific route acquired by the second acquisition processing unit 82.

For example, the first notification processing unit 83 can display a guidance screen including the specific route acquired by the second acquisition processing unit 82, on the operation display unit 12 of the vehicle 1. For example, the guidance screen can include a map that includes the specific route, and a message that recommends the user of the vehicle 1 to drive along the specific route to the specific business place and ask the staff of the specific business place to perform work for eliminating the deflation state of the tires 2. Accordingly, it can be possible to guide the user of the vehicle 1 to the specific business place.

The server 3 may be connected in advance to the portable terminal carried by the user of the vehicle 1 so as to be able to communicate therewith. In this case, the first notification processing unit 83 may display a guidance screen including the specific route acquired by the second acquisition processing unit 82, on a display unit of the portable terminal carried by the user of the vehicle 1.

Also, the server 3 may acquire in advance an email address of the portable terminal carried by the user of the vehicle 1. In this case, the first notification processing unit 83 may send an email containing the guidance screen to the email address of the portable terminal carried by the user of the vehicle 1.

The second determination processing unit 84 can determine whether or not the vehicle 1 is traveling along the specific route, after the specific route is notified by the first notification processing unit 83.

For example, the second determination processing unit 84 can communicate with the vehicle 1, and can acquire the vehicle position information acquired by the vehicle 1 after the specific route is notified, from the vehicle 1. Then, the second determination processing unit 84 can determine whether or not the vehicle 1 is traveling along the specific route, based on the vehicle position information acquired from the vehicle 1. For example, if the vehicle 1 has traveled along the specific route to the intermediate point on the specific route, the second determination processing unit 84 can determine that the vehicle 1 is traveling along the specific route. If the vehicle 1 has deviated from the specific route before reaching the intermediate point on the specific route, the second determination processing unit 84 can determine that the vehicle 1 is not traveling along the specific route.

If it is determined by the second determination processing unit 84 that the vehicle 1 is not traveling along the specific route, the second notification processing unit 85 can notify a predetermined first notification destination outside the vehicle 1 that it has been determined that the vehicle 1 is not traveling along the specific route.

For example, the first notification destination is an insurance company that has an automobile insurance contract with the user of the vehicle 1. If the vehicle 1 is a rental vehicle such as a rental car, the first notification destination may be a rental business operator that conducts rental business for the vehicle 1.

For example, the server 3 can be connected in advance to an information processing device corresponding to the first notification destination, such as a personal computer, so as to be able to communicate therewith. Then, the second notification processing unit 85 can display a message indicating that it has been determined by the second determination processing unit 84 that the vehicle 1 is not traveling along the specific route, and information about the user of the vehicle 1 on a display unit of the information processing device corresponding to the first notification destination. Accordingly, if the first notification destination is the insurance company, it can be possible to consider increasing the insurance premium, etc. If the first notification destination is the rental business operator, it can be possible to consider increasing the rental fee for the vehicle 1, etc.

The server 3 may acquire in advance an email address of the information processing device corresponding to the first notification destination. In this case, the second notification processing unit 85 may send an email containing a message indicating that it has been determined by the second determination processing unit 84 that the vehicle 1 is not traveling along the specific route, and the information about the user of the vehicle 1 to the email address of the information processing device corresponding to the first notification destination.

If it is determined by the second determination processing unit 84 that the vehicle 1 is traveling along the specific route, the third notification processing unit 86 can notify a second notification destination corresponding to the specific business place that the vehicle 1 on which the tires 2 in the deflation state are mounted is traveling toward the specific business place.

For example, the second notification destination can be the specific business place. The second notification destination may be a manager who manages a plurality of such business places, or the like.

For example, the server 3 can be connected in advance to the information processing device corresponding to the second notification destination, so as to be able to communicate therewith. Then, the third notification processing unit 86 can display a message indicating that it has been determined by the second determination processing unit 84 that the vehicle 1 is traveling along the specific route, and information for identifying the vehicle 1 (the vehicle type, the color of the vehicle body, the vehicle registration number, etc.) on the display unit of the information processing device corresponding to the second notification destination. Accordingly, at the specific business place, it can be possible to make preparations to respond to the visit of the vehicle 1. Specifically, at the specific business place, it can be possible to make preparations to adjust the air pressure of the tire 2 of the vehicle 1 or replace the tire 2.

The server 3 may acquire in advance the email address of the information processing device corresponding to the second notification destination. In this case, the third notification processing unit 86 may send an email containing a message indicating that it has been determined by the second determination processing unit 84 that the vehicle 1 is traveling along the specific route, and the information for identifying the vehicle 1 to the email address of the information processing device corresponding to the second notification destination.

Hereinafter, a determination method of the present disclosure will be described together with an example of a procedure for each process executed by the control unit 11. Some or all of the method can be performed via a non-transitory computer-readable storage medium (or media) having stored thereon instructions that, when executed by one or more processors, such as processor(s), causes the one or more processors to perform some or all of the method.

### [Related Value Acquisition Process]

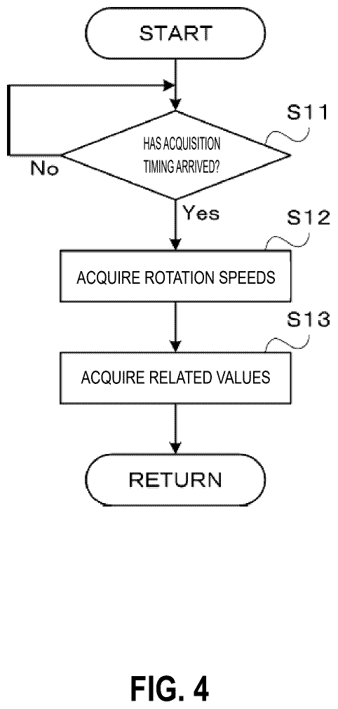

First, an example of the procedure for a related value acquisition process executed by the control unit 11 will be described with reference to FIG. 4. Here, steps S11, S12 . . . represent numbers of the processing procedure (steps) executed by the control unit 11. The related value acquisition process can be executed while the vehicle 1 is traveling.

### <Step S11>

First, in step S11, the control unit 11 can determine whether or not the acquisition timing has arrived.

Here, if the control unit 11 determines that the acquisition timing has arrived (Yes side in S11), the control unit 11 can shift the process to step S12. If the acquisition timing has not arrived (No side in S11), the control unit 11 can wait for the arrival of the acquisition timing in step S11.

### <Step S12>

In step S12, the control unit 11 can acquire the rotation speed of each of the tires 2.

Specifically, the control unit 11 can acquire the rotation speed of each of the tires 2 using each of the wheel speed sensors 13.

### <Step S13>

In step S13, the control unit 11 can acquire the four related values. The processes in step S11 to step S13 can be an example of an acquisition step of the present disclosure, and can be executed by the first acquisition processing unit 71 of the control unit 11.

Specifically, the control unit 11 can acquire DEL1, based on the rotation speed of each of the tires 2 acquired by the process in step S12. The control unit 11 can also acquire DEL3, based on the rotation speed of each of the tires 2 acquired by the process in step S12. In addition, the control unit 11 can acquire the resonance frequency of the tire 2A, based on the rotation speed of the tire 2A acquired by the process in step S12. Moreover, the control unit 11 can acquire the resonance frequency of the tire 2B, based on the rotation speed of the tire 2B acquired by the process in step S12.

### [Deflation State Detection Process]

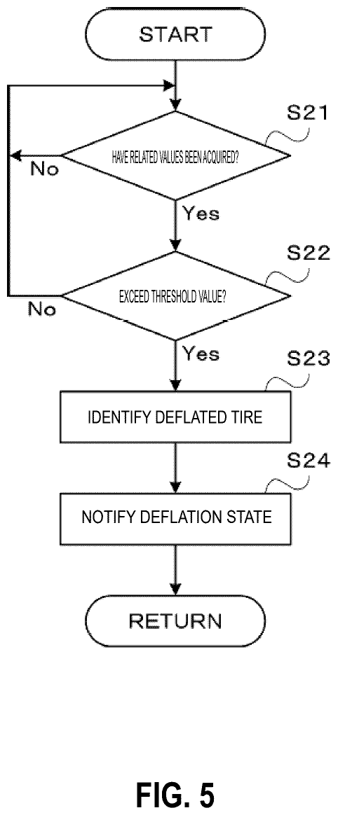

Next, an example of the procedure for a deflation state detection process executed by the control unit 11 will be described with reference to FIG. 5. The deflation state detection process can be executed while the vehicle 1 is traveling.

### <Step S21>

First, in step S21, the control unit 11 can determine whether or not the four related values have been acquired. That is, the control unit 11 can determine whether or not the process in step S13 of the related value acquisition process has been executed.

Here, if the control unit 11 determines that the four related value have been acquired (Yes side in S21), the control unit 11 can shift the process to step S22. If the four related values have not been acquired (No side in S21), the control unit 11 can wait for the acquisition of the four related values in step S21.

### <Step S22>

In step S22, for any of the four related values acquired by the process in step S21, the control unit 11 can determine whether or not the difference between the related value and the reference value exceeds the threshold value. The process in step S22 can be an example of a detection step of the present disclosure, and can be executed by the detection processing unit 72 of the control unit 11.

Here, if, for any of the four related values, the control unit 11 can determine that the difference between the related value and the reference value exceeds the threshold value (Yes side in S22), the control unit 11 can shift the process to step S23. If, for all of the four related values, the differences between the related values and the reference values do not exceed the threshold value (No side in S22), the control unit 11 can shift the process to step S21.

### <Step S23>

In step S23, the control unit 11 can identify the deflated tire 2.

Specifically, if the difference between the resonance frequency of the tire 2A and the reference value corresponding to this resonance frequency exceeds the threshold value, the control unit 11 can determine that the tire 2A has been deflated.

If the difference between the resonance frequency of the tire 2B and the reference value corresponding to this resonance frequency exceeds the threshold value, the control unit 11 can determine that the tire 2B has been deflated.

If the difference between the related value of either DEL1 or DEL3 and the reference value corresponding to this related value exceeds the threshold value, the control unit 11 can identify the deflated tire 2, based on the combination of the sign of DEL1 and the sign of DEL3.

### <Step S24>

In step S24, the control unit 11 can notify the user of the vehicle 1 that the deflation state of the tires 2 has been detected.

For example, the control unit 11 can display a message indicating that the deflation state of the tires 2 has been detected and also indicating the deflated tire 2, on the operation display unit 12. In addition, the control unit 11 can periodically generate the warning sound.

### [Update Process]

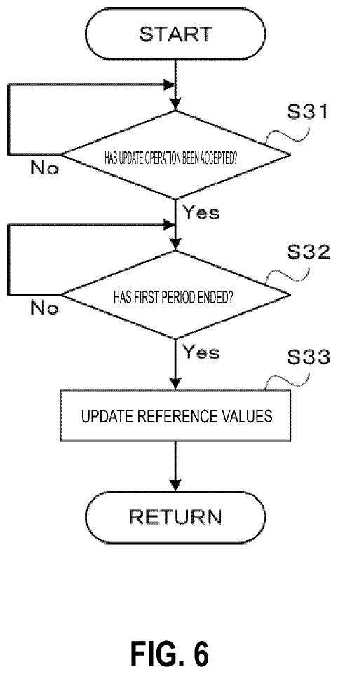

Next, an example of the procedure for an update process executed by the control unit 11 will be described with reference to FIG. 6.

### <Step S31>

First, in step S31, the control unit 11 can determine whether or not the update operation has been accepted.

Here, if the control unit 11 determines that the update operation has been accepted (Yes side in S31), the control unit 11 can shift the process to step S32. If the update operation has not been accepted (No side in S31), the control unit 11 can wait for the acceptance of the update operation in step S31.

### <Step S32>

First, in step S32, the control unit 11 can determine whether or not the first period has ended.

Specifically, if the number of times the acquisition timing has arrived from the time of acceptance of the update operation has reached a predetermined number, the control unit 11 can determine that the first period has ended.

Here, if the control unit 11 determines that the first period has ended (Yes side in S32), the control unit 11 can shift the process to step S33. If the first period has not ended (No side in S32), the control unit 11 can wait for the end of the first period in step S32.

### <Step S33>

In step S33, the control unit 11 can update the reference values, based on the related values acquired during the first period. The process in step S33 can be an example of an update step of the present disclosure, and can be executed by the update processing unit 73 of the control unit 11.

Specifically, the control unit 11 can set any of DEL1s acquired during the first period, as a new reference value corresponding to DEL1.

The control unit 11 can set any of DEL3s acquired during the first period, as a new reference value corresponding to DEL3.

The control unit 11 can set any of resonance frequencies of the tire 2A acquired during the first period, as a new reference value corresponding to the resonance frequency of the tire 2A.

The control unit 11 can set any of resonance frequencies of the tire 2B acquired during the first period, as a new reference value corresponding to the resonance frequency of the tire 2B.

### [Operation Determination Process]

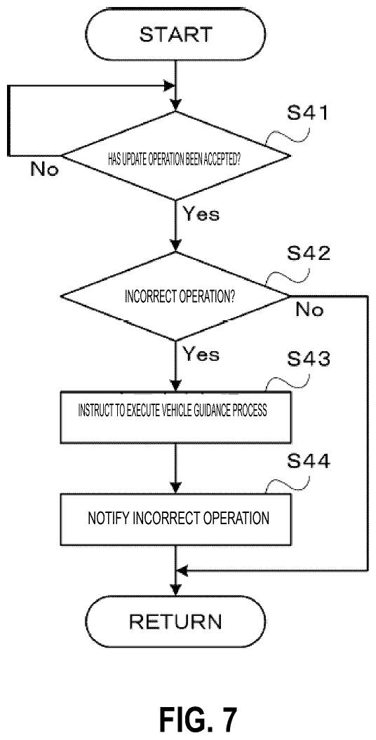

Next, an example of the procedure for an operation determination process executed by the control unit 11 will be described with reference to FIG. 7.

### <Step S41>

First, in step S41, the control unit 11 can determine whether or not the update operation has been accepted.

Here, if the control unit 11 determines that the update operation has been accepted (Yes side in S41), the control unit 11 can shift the process to step S42. If the update operation has not been accepted (No side in S41), the control unit 11 can wait for the acceptance of the update operation in step S41.

### <Step S42>

In step S42, based on the stop status and the stop location of the vehicle 1 during the second period from the time when the deflation state of the tires 2 was last detected by the deflation state detection process to the time when the last update operation was accepted, the control unit 11 can determine whether or not the update operation is an incorrect operation. The process in step S42 can be an example of a determination step of the present disclosure, and can be executed by the first determination processing unit 74 of the control unit 11.

Specifically, if the vehicle 1 has not stopped during the second period, the control unit 11 can determine that the update operation is an incorrect operation.

If the vehicle 1 has stopped during the second period and the stopped time of the vehicle 1 does not exceed the specific time, the control unit 11 can determine that the update operation is an incorrect operation.

If the vehicle 1 has stopped during the second period, the stopped time of the vehicle 1 exceeds the specific time, and the stop location of the vehicle 1 is not at the business place, the control unit 11 can determine that the update operation is an incorrect operation.

If the vehicle 1 has stopped during the second period, the stopped time of the vehicle 1 exceeds the specific time, and the stop location of the vehicle 1 is at the business place, the control unit 11 can determine that the update operation is not an incorrect operation, that is, the update operation is a correct operation.

Here, if the control unit 11 determines that the update operation is an incorrect operation (Yes side in S42), the control unit 11 can shift the process to step S43. If the update operation is not an incorrect operation (No side in S42), the control unit 11 can shift the process to step S41.

### <Step S43>

In step S43, the control unit 11 can instruct the server 3 to execute a vehicle guidance process described later.

### <Step S44>

In step S44, the control unit 11 can notify the user of the vehicle 1 that the update operation has been determined to be an incorrect operation.

For example, the control unit 11 can display a message indicating that the update operation has been determined to be an incorrect operation, on the operation display unit 12. In addition, the control unit 11 can periodically generate the warning sound. Moreover, the control unit 11 can notify the user of the vehicle 1 that the update operation has been determined to be an incorrect operation, at the timing when a process in step S54 of the vehicle guidance process described later can be executed.

### [Vehicle Guidance Process]

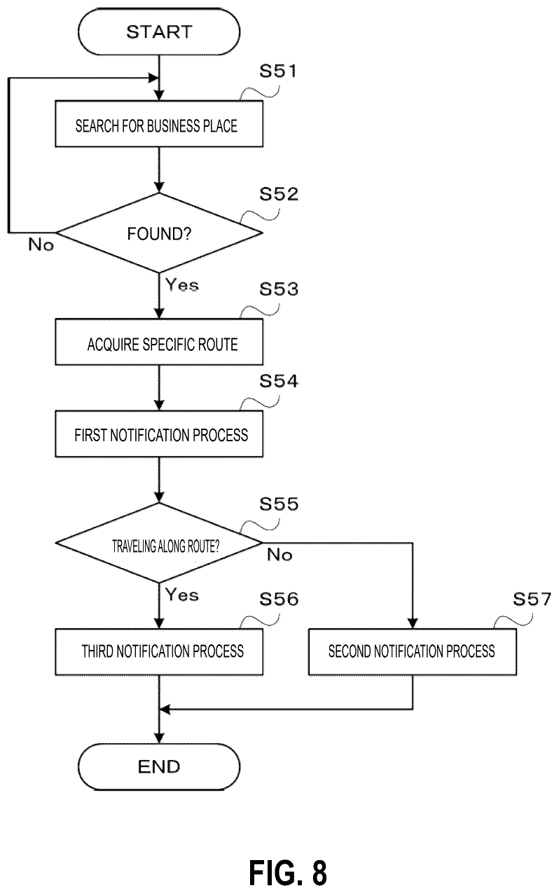

Next, an example of the procedure for the vehicle guidance process executed by the control unit 51 of the server 3 will be described with reference to FIG. 8. The vehicle guidance process can be executed when an instruction to execute the vehicle guidance process is received from the control unit 11 of the vehicle 1.

### <Step S51>

First, in step S51, the control unit 51 can search for the business place that exists within the specific range from the current position of the vehicle 1. The process in step S51 can be executed by the search processing unit 81 of the control unit 51.

Specifically, the control unit 51 can communicate with the vehicle 1, and can acquire the vehicle position information last acquired by the vehicle 1, from the vehicle 1. In addition, based on the vehicle position information acquired from the vehicle 1 and the map data stored in the storage unit 54, the control unit 51 can search for the business place that exists within the specific range from the position of the vehicle 1 that is based on the acquired vehicle position information.

### <Step S52>

In step S52, the control unit 51 can determine whether or not the business place has been found by the process in step S51.

Here, if the control unit 51 determines that the business place has been found (Yes side in S52), the control unit 51 can shift the process to step S53. If the business place has not been found (No side in S52), the control unit 51 can wait for the arrival of the next search timing and shifts the process to step S51.

### <Step S53>

In step S53, the control unit 51 can acquire the specific route to the specific business place closest to the current position of the vehicle 1 among the business places found by the process in step S51. The process in step S53 can be executed by the second acquisition processing unit 82 of the control unit 51.

Specifically, the control unit 51 can acquire the specific route, based on the map data stored in the storage unit 54.

### <Step S54>

In step S54, the control unit 51 can execute a first notification process of notifying the person in the vehicle 1 of the specific route acquired by the process in step S53. The process in step S54 can be executed by the first notification processing unit 83 of the control unit 51.

For example, the control unit 51 can display the guidance screen including the specific route acquired by the process in step S53, on the operation display unit 12 of the vehicle 1.

### <Step S55>

In step S55, the control unit 51 can determine whether or not the vehicle 1 is traveling along the specific route notified by the process in step S54. The process in step S55 can be executed by the second determination processing unit 84 of the control unit 51.

Specifically, the control unit 51 can communicate with the vehicle 1, and can acquire the vehicle position information acquired by the vehicle 1 after the specific route is notified, from the vehicle 1. Then, the control unit 51 can determine whether or not the vehicle 1 is traveling along the specific route, based on the vehicle position information acquired from the vehicle 1.

Here, if the control unit 51 determines that the vehicle 1 is traveling along the specific route (Yes side in S55), the control unit 51 can shift the process to step S56. If the vehicle 1 is not traveling along the specific route (No side in S55), the control unit 51 can shift the process to step S57.

### <Step S56>

In step S56, the control unit 51 can execute a third notification process of notifying the second notification destination corresponding to the specific business place that the vehicle 1 on which the tires 2 in the deflation state are mounted is traveling toward the specific business place. The process in step S56 can be executed by the third notification processing unit 86 of the control unit 51.

Specifically, the control unit 51 can display a message indicating that it has been determined by the process in step S55 that the vehicle 1 is traveling along the specific route, and the information for identifying the vehicle 1 on the display unit of the information processing device corresponding to the second notification destination.

### <Step S57>

In step S57, the control unit 51 can execute a second notification process of notifying the first notification destination outside the vehicle 1 that it has been determined by the process in step S55 that the vehicle 1 is not traveling along the specific route. The process in step S57 can be executed by the second notification processing unit 85 of the control unit 51.

Specifically, the control unit 51 can display a message indicating that it has been determined by the process in step S55 that the vehicle 1 is not traveling along the specific route, and the information about the user of the vehicle 1 on the display unit of the information processing device corresponding to the first notification destination.

As described above, in the deflation state detection system 100, whether or not the update operation is an incorrect operation can be determined based on the stop status of the vehicle 1 during the second period from the time of detection of the deflation state of the tires 2 to the time of acceptance of the update operation. Accordingly, it can be possible to determine that the update operation is an incorrect operation, only if it can be determined that it is impossible for the user of the vehicle 1 to adjust the air pressure of the tire 2 or replace the tire 2 during the second period, such as if the vehicle 1 has not stopped during the second period. Therefore, compared to a configuration in which the update operation is determined to be an incorrect operation if the difference between the two related values acquired before and after the update operation is accepted is included within a predetermined range, with one or more embodiments of the present disclosure it can be possible to inhibit the update operation from being determined to be an incorrect operation when the deflation state of the tires 2 is eliminated by replacing the tire 2.

The control unit 11 of the vehicle 1 may include some or all of the search processing unit 81, the second acquisition processing unit 82, the first notification processing unit 83, the second determination processing unit 84, the second notification processing unit 85, and the third notification processing unit 86.

The embodiment of the present disclosure described above includes disclosure items (1) to (10) described below.

A disclosure item (1) is a deflation state detection system including: a first acquisition processing unit configured to acquire a related value that is related to an air pressure of each pneumatic tire mounted on a vehicle, based on a rotation speed of the pneumatic tire, each time a predetermined acquisition timing arrives; a detection processing unit configured to detect a deflation state of the pneumatic tire, based on the related value acquired by the first acquisition processing unit and a predetermined reference value; an update processing unit configured to, if a predetermined update operation is accepted, update the reference value, based on the related value acquired during a first period including a time of acceptance of the update operation; and a first determination processing unit configured to determine whether or not the update operation is an incorrect operation, based on a stop status of the vehicle during a second period from a time of detection of the deflation state to the time of acceptance of the update operation.

With this system, whether or not the update operation is an incorrect operation is determined based on the stop status of the vehicle during the second period from the time of detection of the deflation state to the time of acceptance of the update operation. Accordingly, it is possible to determine that the update operation is an incorrect operation, only if it can be determined that it is impossible for the user of the vehicle to adjust the air pressure of the pneumatic tire or replace the pneumatic tire during the second period, such as if the vehicle has not stopped during the second period. Therefore, compared to a configuration in which the update operation is determined to be an incorrect operation if the difference between the two related values acquired before and after the update operation is accepted is included within a predetermined range, it is possible to inhibit the update operation from being determined to be an incorrect operation when the deflation state is eliminated by replacing the pneumatic tire.

A disclosure item (2) is the deflation state detection system according to the disclosure item (1), wherein the first determination processing unit determines that the update operation is an incorrect operation, if a continuation time of a stopped state of the vehicle during the second period does not exceed a predetermined specific time.

A disclosure item (3) is the deflation state detection system according to the disclosure item (1) or (2), wherein the first determination processing unit determines whether or not the update operation is an incorrect operation, based on the stop status and a stop location of the vehicle during the second period.

With this system, if the vehicle has stopped during the second period, it is possible to determine whether or not the update operation is an incorrect operation, in consideration of the stop location. Therefore, it is possible to increase the accuracy of determining whether or not the update operation is an incorrect operation.

A disclosure item (4) is the deflation state detection system according to any one of the disclosure items (1) to (3), wherein the first determination processing unit determines whether or not the update operation is an incorrect operation, based on the stop status of the vehicle during the second period, the related value acquired during the second period, and the related value acquired after the second period has elapsed.

With this system, it is possible to determine whether or not the update operation is an incorrect operation, in consideration of the two related values acquired before and after the update operation is accepted. Therefore, it is possible to increase the accuracy of determining whether or not the update operation is an incorrect operation.

A disclosure item (5) is the deflation state detection system according to any one of the disclosure items (1) to (4), further including: a search processing unit configured to search for a business place where it is possible to eliminate the deflation state, if it is determined by the first determination processing unit that the update operation is an incorrect operation; a second acquisition processing unit configured to acquire a specific route to a specific business place closest to a current position of the vehicle among the business places found by the search processing unit; and a first notification processing unit configured to notify a person in the vehicle of the specific route.

With this system, it is possible to guide the vehicle to the nearest business place if the update operation is determined to be an incorrect operation.

A disclosure item (6) is the deflation state detection system according to the disclosure item (5), wherein the search processing unit searches for the business place that exists within a predetermined specific range from the current position of the vehicle, and if the business place is not found, the search processing unit searches for the business place each time a predetermined search timing arrives until the business place is found.

With this system, it is possible to avoid guiding the vehicle to the business place that is far from the planned traveling route of the vehicle.

A disclosure item (7) is the deflation state detection system according to the disclosure item (5) or (6), further including: a second determination processing unit configured to determine whether or not the vehicle is traveling along the specific route, after the specific route is notified by the first notification processing unit; and a second notification processing unit configured to, if it is determined by the second determination processing unit that the vehicle is not traveling along the specific route, notify a predetermined first notification destination outside the vehicle that it has been determined that the vehicle is not traveling along the specific route.

With this system, it is possible to make the first notification destination outside the vehicle recognize that the vehicle is not traveling along the specific route. Therefore, by setting the insurance company or the like as the first notification destination, it is possible to impose a penalty such as an increase in insurance premium at the first notification destination for the vehicle not eliminating the deflation state.

A disclosure item (8) is the deflation state detection system according to any one of the disclosure item (5) to (7), further including: a second determination processing unit configured to determine whether or not the vehicle is traveling along the specific route, after the specific route is notified by the first notification processing unit; and a third notification processing unit configured to, if it is determined by the second determination processing unit that the vehicle is traveling along the specific route, notify a second notification destination corresponding to the specific business place that the vehicle on which the pneumatic tire in the deflation state is mounted is traveling toward the specific business place.

With this system, it is possible to make the second notification destination corresponding to the specific business place recognize that the vehicle is traveling toward the specific business place. Therefore, at the specific business place, it is possible to make preparations to respond to the visit of the vehicle. Specifically, at the specific business place, it is possible to make preparations to adjust the air pressure of the pneumatic tire of the vehicle or replace the pneumatic tire.

A disclosure item (9) is a determination method executed by one or more processors, the determination method including: an acquisition step of acquiring a related value that is related to an air pressure of each pneumatic tire mounted on a vehicle, based on a rotation speed of the pneumatic tire, each time a predetermined acquisition timing arrives; a detection step of detecting a deflation state of the pneumatic tire, based on the related value acquired by the acquisition step and a predetermined reference value; an update step of, if a predetermined update operation is accepted, updating the reference value, based on the related value acquired during a first period including a time of acceptance of the update operation; and a determination step of determining whether or not the update operation is an incorrect operation, based on a stop status of the vehicle during a second period from a time of detection of the deflation state to the time of acceptance of the update operation.

With this method, as in the system of the disclosure item (1), it is possible to inhibit the update operation from being determined to be an incorrect operation when the deflation state is eliminated by replacing the pneumatic tire.

A disclosure item (10) according to disclosure item (9) is said determining that the update operation is an incorrect operation is performed under a condition where a continuation time of a stopped state of the vehicle during the second period does not exceed a predetermined specific time.

A disclosure item (11) according to disclosure item (9) or (1) is said determining determines whether or not the update operation is the incorrect operation, based on the stop status and a stop location of the vehicle during the second period.

A disclosure item (12) according to any one of disclosure item (9) to (11) is said determining whether or not the update operation is an incorrect operation, based on the stop status of the vehicle during the second period, the related value acquired during the second period, and the related value acquired after the second period has elapsed.

A disclosure item (13) according to any one of disclosure item (9) to (12) further comprising: searching for a business place where it is possible to eliminate the deflation state, if it is determined that the update operation is an incorrect operation; acquiring a specific route to a specific business place closest to a current position of the vehicle among the business places found by the search; and notifying a person in the vehicle of the specific route.

A disclosure item (14) any one of disclosure item (9) to (13) wherein said searching for a business place searches within a predetermined specific range from the current position of the vehicle, and under a condition where the business place is not found, said searching for the business place is performed each time a predetermined search timing arrives until the business place is found.

A disclosure item (15) is a program for causing one or more processors to execute: an acquisition step of acquiring a related value that is related to an air pressure of each pneumatic tire mounted on a vehicle, based on a rotation speed of the pneumatic tire, each time a predetermined acquisition timing arrives; a detection step of detecting a deflation state of the pneumatic tire, based on the related value acquired by the acquisition step and a predetermined reference value; an update step of, if a predetermined update operation is accepted, updating the reference value, based on the related value acquired during a first period including a time of acceptance of the update operation; and a determination step of determining whether or not the update operation is an incorrect operation, based on a stop status of the vehicle during a second period from a time of detection of the deflation state to the time of acceptance of the update operation.

With this program, as in the system of the disclosure item (1), it is possible to inhibit the update operation from being determined to be an incorrect operation when the deflation state is eliminated by replacing the pneumatic tire.

The present disclosure may be directed to a computer-readable storage medium having the program of the disclosure item (15) stored non-temporarily therein.

A disclosure item (16) according to disclosure item (15) above can include for the method searching for a business place where it is possible to eliminate the deflation state, if it is determined that the update operation is an incorrect operation; acquiring a specific route to a specific business place closest to a current position of the vehicle among the business places found by the search; and notifying a person in the vehicle of the specific route.

A disclosure item (17) according to disclosure item (15) or (16) can include for the method said determining whether or not the vehicle is traveling along the specific route, is performed after the specific route is notified; and under a condition where it is determined that the vehicle is not traveling along the specific route, the method notifies a predetermined first notification destination outside the vehicle that it has been determined that the vehicle is not traveling along the specific route.

A disclosure item (18) according to any one of disclosure items (15) to (17) wherein said determining whether or not the vehicle is traveling along the specific route, is performed after the specific route is notified; and under a condition where it is determined that the vehicle is traveling along the specific route, the method comprises notifying a second notification destination corresponding to the specific business place that the vehicle on which the pneumatic tire in the deflation state is mounted is traveling toward the specific business place.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Use of the terms “data,” “content,” “information” and similar terms may be used interchangeably, according to some example embodiments of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Aspects of the present disclosure have been described above with reference to flowchart illustrations and/or block diagrams of methods, apparatus (systems) and computer program products according to embodiments of the present disclosure. In this regard, the flowchart and block diagrams in the Figures illustrate the architecture, functionality, and operation of possible implementations of systems, methods and computer program products according to various embodiments of the present disclosure. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. A deflation state detection system comprising:
circuitry configured to
acquire a related value that is related to an air pressure of each pneumatic tire mounted on a vehicle, based on a rotation speed of the pneumatic tire, each time a predetermined acquisition timing arrives;
detect a deflation state of the pneumatic tire, based on the acquired related value and a predetermined reference value;
under a condition where a predetermined update operation is accepted, update the reference value, based on the related value acquired during a first period including a time of acceptance of the update operation; and
determine whether or not the update operation is an incorrect operation, based on a stop status of the vehicle during a second period from a time of detection of the deflation state to the time of acceptance of the update operation.

2. The deflation state detection system according to claim 1, wherein the circuitry determines that the update operation is an incorrect operation, under a condition where a continuation time of a stopped state of the vehicle during the second period does not exceed a predetermined specific time.

3. The deflation state detection system according to claim 1, wherein the circuitry determines whether or not the update operation is an incorrect operation, based on the stop status and a stop location of the vehicle during the second period.

4. The deflation state detection system according to claim 1, wherein the circuitry determines whether or not the update operation is an incorrect operation, based on the stop status of the vehicle during the second period, the related value acquired during the second period, and the related value acquired after the second period has elapsed.

5. The deflation state detection system according to claim 1, wherein the circuitry is configured to
search for a business place where it is possible to eliminate the deflation state, if it is determined that the update operation is an incorrect operation;
acquire a specific route to a specific business place closest to a current position of the vehicle among the business places found by the search; and
notify a person in the vehicle of the specific route.

6. The deflation state detection system according to claim 5, wherein
the circuitry searches for the business place that exists within a predetermined specific range from the current position of the vehicle, and
under a condition where the business place is not found, the circuitry searches for the business place each time a predetermined search timing arrives until the business place is found.

7. The deflation state detection system according to claim 5, wherein the circuitry is configured to
determine whether or not the vehicle is traveling along the specific route, after the specific route is notified; and
under a condition where it is determined that the vehicle is not traveling along the specific route, notify a predetermined first notification destination outside the vehicle that it has been determined that the vehicle is not traveling along the specific route.

8. The deflation state detection system according to claim 5, wherein the circuitry is configured to
determine whether or not the vehicle is traveling along the specific route, after the specific route is notified; and
under a condition where it is determined that the vehicle is traveling along the specific route, notify a second notification destination corresponding to the specific business place that the vehicle on which the pneumatic tire in the deflation state is mounted is traveling toward the specific business place.

9. A determination method executed by one or more processors, the determination method comprising:
acquiring a related value that is related to an air pressure of each pneumatic tire mounted on a vehicle, based on a rotation speed of the pneumatic tire, each time a predetermined acquisition timing arrives;
detecting, using an electronic detector, a deflation state of the pneumatic tire, based on the related value acquired by said acquiring and a predetermined reference value;
updating, under a condition where a predetermined update operation is accepted, the reference value, based on the related value acquired during a first period including a time of acceptance of the update operation; and
determining whether or not the update operation is an incorrect operation, based on a stop status of the vehicle during a second period from a time of detection of the deflation state to the time of acceptance of the update operation.

10. The determination method according to claim 9, wherein said determining that the update operation is an incorrect operation is performed under a condition where a continuation time of a stopped state of the vehicle during the second period does not exceed a predetermined specific time.

11. The determination method according to claim 9, wherein said determining determines whether or not the update operation is the incorrect operation, based on the stop status and a stop location of the vehicle during the second period.

12. The determination method according to claim 9, wherein said determining whether or not the update operation is an incorrect operation, based on the stop status of the vehicle during the second period, the related value acquired during the second period, and the related value acquired after the second period has elapsed.

13. The determination method according to claim 9, further comprising:
searching for a business place where it is possible to eliminate the deflation state, if it is determined that the update operation is an incorrect operation;
acquiring a specific route to a specific business place closest to a current position of the vehicle among the business places found by the search; and
notifying a person in the vehicle of the specific route.

14. The determination method according to claim 13, wherein
said searching for a business place searches within a predetermined specific range from the current position of the vehicle, and
under a condition where the business place is not found, said searching for the business place is performed each time a predetermined search timing arrives until the business place is found.

15. A non-transitory computer-readable storage medium having stored thereon instructions that, when executed by one or more processors, causes the one or more processors to perform a method comprising:
an acquisition step of acquiring a related value that is related to an air pressure of each pneumatic tire mounted on a vehicle, based on a rotation speed of the pneumatic tire, each time a predetermined acquisition timing arrives;
a detection step of detecting a deflation state of the pneumatic tire, based on the related value acquired by the acquisition step and a predetermined reference value;
an update step of, if a predetermined update operation is accepted, updating the reference value, based on the related value acquired during a first period including a time of acceptance of the update operation; and
a determination step of determining whether or not the update operation is an incorrect operation, based on a stop status of the vehicle during a second period from a time of detection of the deflation state to the time of acceptance of the update operation.

16. The non-transitory computer-readable storage medium according to claim 15, wherein the method further comprises:
searching for a business place where it is possible to eliminate the deflation state, if it is determined that the update operation is an incorrect operation;
acquiring a specific route to a specific business place closest to a current position of the vehicle among the business places found by the search; and
notifying a person in the vehicle of the specific route.

17. The non-transitory computer-readable storage medium according to claim 16, wherein
said determining whether or not the vehicle is traveling along the specific route, is performed after the specific route is notified; and
under a condition where it is determined that the vehicle is not traveling along the specific route, the method notifies a predetermined first notification destination outside the vehicle that it has been determined that the vehicle is not traveling along the specific route.

18. The non-transitory computer-readable storage medium according to claim 16, wherein
said determining whether or not the vehicle is traveling along the specific route, is performed after the specific route is notified; and
under a condition where it is determined that the vehicle is traveling along the specific route, the method comprises notifying a second notification destination corresponding to the specific business place that the vehicle on which the pneumatic tire in the deflation state is mounted is traveling toward the specific business place.
